(19) United States
(12) Patent Application Publication
(10) Pub. No.: US 2017/0121493 A1
(43) Pub. Date: May 4, 2017

(54) Biomaterial Composite

(71) Applicant: Hans-Peter Meyerhoff, Bensheim (DE)

(72) Inventor: Hans-Peter Meyerhoff, Bensheim (DE)

(21) Appl. No.: 15/301,412

(22) PCT Filed: Apr. 2, 2015
(86) PCT No.: PCT/EP2015/057420

§ 371 Date: Oct. 3, 2016

(30) Foreign Application Priority Data
Apr. 4, 2014 (DE) 10 2014 104 869.5

(51) Int. Cl. C08K 3/36; B29B 9/06; B29B 9/14; C08K 7/14

(52) U.S. Cl. CPC C08K 3/36; C08K 7/14; B29B 9/06; B29B 9/14; B29K 2309/08

(57) ABSTRACT

A bio-material includes at least one thermoplastic, at least one biological filling material, and long glass fibres.

### FIELD OF THE INVENTION

The invention relates to fiber-reinforced plastics with biological filler materials.

Biomaterials are understood to mean plastics based fully or in relevant proportions on renewable raw materials. In view of rising costs for oil, the use of biomaterials is of interest not just for reasons of sustainability but also on the basis of economic considerations.

There have been a number of recent examples of biomaterials, usually oil-based plastics with a particular proportion of biologically produced filler materials and/or fibers.

A relatively new field is the replacement of the plastics with plastics made from renewable raw materials, for example polypropylene from sugarcane.

Very frequently, biological filler material based on wood is used. This limits the temperatures in the course of processing to below 200° C.

A common problem with such biomaterials is their often inadequate stability in relation to modulus of elasticity and/or impact resistance.

Moreover, the effect of introduction of a usually hydrophilic material into a hydrophobic environment, such as plastics, is that the biomaterials (e.g. wood fibers, etc.) have a tendency to absorb water. This is usually associated with a change in volume, for example by 1% to 6%. This makes these materials unsuitable for outdoor applications or for moist environments. Any aftertreatment (drilling, machining, working) opens up the pores of the wood fibers—and leads to a capillary effect and hence promotes the swelling of the material.

In addition, odor nuisance resulting from the organic component is also known, as is damage to the steel tool surfaces, depending on the steel quality.

The UV resistance of such materials is also a problem.

There is therefore a need for biomaterials which overcome the disadvantages of the known biomaterials (e.g. WPC, wood plastic composite) and especially have low absorption of water or swelling, and high impact resistance.

At the same time, it is advantageous when the biomaterial does not compete with food production.

This object is achieved by the inventions having the features of the independent claims. Advantageous developments of the invention are identified in the dependent claims. The wording of all the claims is hereby incorporated by reference into the content of this description. The inventions also encompass all viable combinations, and especially all the mentioned combinations, of independent and/or dependent claims.

The object is achieved by a composition comprising
a) at least one thermoplastic;
b) at least one biological filler material having a silicon dioxide content of at least 60% by weight;
c) at least one long glass fiber having a length of at least 0.5 mm and a diameter of 3 to 25 μm.

The biological filler increases the content of renewable raw materials in the composite material. This makes it possible to dispense with the usually oil-based plastics.

More particularly, the long glass fibers having the dimensions mentioned lead to high impact resistance and tensile strength, in spite of a high proportion of biological filler.

In connection with this invention, the terms “long glass fibers” and “filaments” are used as synonyms and refer to an endless or continuous glass fiber, the length of which is limited merely by the capacity of the coil on which the filament has been wound. The fiber length of the filaments is determined by the cut length of the pellets or other further processing steps. A long glass fiber has a length of at least 0.5 mm. Typically, a fiber filament has a diameter of 3 to 25 and preferably 8 to 22 micrometers. When a composition or a shaped body comprises a multitude of long glass fibers, the length of the long glass fibers is understood to mean the mean fiber length. The fibers therefore have a ratio of length to diameter of at least 20.

Thermoplastic (a) is understood to mean any thermo-plastically formable polymers, which may be new or recyclate/ground material composed of old thermoplastic polymers. Preference is given to thermoplastics having a viscosity corresponding to a melt index (MFI, 230° C./2.16 kg) of polypropylene (PP) of at least about 20 g/10 min. Preference is given to those whose viscosity corresponds to an MFI of PP of 20 to 300 g/10 min, more preferably of 50 g/10 min to 200 g/10 min. These may, for example, be polyolefins, polyamides, polyimides, polystyrenes, polycarbonates, polyesters, polyethers, polysulfones, for example polyethylene terephthalate or polybutylene terephthalates, polyether ketones, polyether sulfones, polyether imides, polyphenylene oxide, polyphenylene sulfide, low-density polyethylene (LDPE), high-density polyethylene (HDPE), polystyrene or polyvinyl acetate, or the copolymers or mixed polymers thereof. Examples of mixed polymers are acrylic ester-styrene-acrylonitrile (ASA), acrylonitrile-butadiene-styrene (ABS), styrene-acrylonitrile copolymer (SAN), alpha-methyl-styrene-acrylonitrile copolymer (AMSAN) or styrene-butadiene-styrene (SBS).

The thermoplastic used may also be polyvinyl acetate.

Polyamides used may, for example, be nylon-6, nylon-6,6, mixtures and corresponding copolymers.

The at least one thermoplastic may also be part of a blend, for example in blends composed of styrene polymers such as SAN with polymethacrylonitrile (PMI) or chlorinated polyethylene, or polyvinyl chloride with methyl acrylate-butadiene-styrene copolymer (MBS), ASA and/or ABS. It is important that the mixture obtained is still a thermoplastic.

Preferably, at least one thermoplastic is a polyolefin, more preferably polypropylene (PP) or polyethylene (PE) and copolymers or mixed polymers thereof, for instance EPDM-modified PP or else in the reactor PP-EPDM prepared types; for example, by the cascade principle, each stage increases the EPDM content by 5%.

The polyolefin may be crystalline or amorphous polyolefin.

In a preferred development of the invention, at least 50% by weight, 60% by weight, 70% by weight, 90% by weight, preferably 100% by weight, of the thermoplastic used is at least one polyolefin.

In a further embodiment of the invention, the polyolefin is likewise obtained at least partly from biological sources, for example sugarcane. Together with the biological filler, it is thus possible to obtain a composite material which has been produced from biological sources to an extent of more than 30% by weight, preferably more than 50% by weight, more preferably more than 65% by weight.

In one embodiment of the invention, the thermoplastic (a) has a mean molecular weight M_{W} in the range from 10 000 to 200 000 Da (measured by ultracentrifuge), preferably from 100 000 to 200 000 Da.

Polyethylene and polypropylene each also include copolymers of, respectively, ethylene and propylene with one or more α-olefin or styrene. Thus, in the context of the present invention, polyethylene also includes copolymers containing, in copolymerized form, as well as ethylene as main monomer (at least 50% by weight), one or more comonomers preferably selected from styrene or α-olefins, for example propylene, 1-butene, 1-hexene, 4-methyl-1-pentene, 1-octene, 1-decene, 1-dodecene, n-α-C₂₂H₄₄, n-α-C₂₄H₄₈ and n-α-C₂₀H₄₀. In the context of the present invention, polypropylene also includes copolymers containing, in copolymerized form, as well as propylene as main monomer (at least 50% by weight), one or more comonomers preferably selected from styrene, ethylene, 1-butene, 1-hexene, 4-methyl-1-pentene, 1-octene, 1-decene, 1-dodecene, n-α-C₂₂H₄₄, n-α-C₂₄H₄₈ and n-α-C₂₀H₄₀.

The compositions preferably contain 10% to 70% by weight, preferably 20% to 70% by weight, more preferably 40% to 60% by weight, of the thermoplastic (a).

Preferably, the glass transition temperature (T_{G}, determinable as the turning point in the DSC diagram) for the at least one thermoplastic is below 150° C., preferably between 60° C. and 120° C.

The biological filler material may come from many different sources. Preference is given to biological fillers having a high proportion of inorganic constituents. Particular preference is given to biological filler materials having an ash content of more than 5 percent by mass, preferably of more than 10 percent by mass (ash content at 815° C. according to DIN 51719). All citations of standards in the measurement of properties, for example DIN 51719, relate to the most recent version of the respective standard at the application date.

Particular preference is given to plant sources having a high proportion of silicon dioxide, more preferably having a proportion of at least 10% by weight, preferably at least 15% by weight (based on the biological filler material, measured by x-ray fluorescence analysis), or more than 20% by weight. Preference is therefore given to sources having a proportion of 10% to 98% by weight, more preferably 15% to 98% by weight or 20% to 98% by weight.

A high proportion of silicon dioxide and an associated relatively low proportion of organic materials ensure that the water absorption of the compositions according to the invention is only low. Preference is given to a water absorption of ≦0.3% by mass, preferably ≦0.2 (measured according to ISO 62).

It may be necessary to dry the biological filler material prior to use. This is generally unnecessary, since it is accomplished by the degassing in the extruder and later in the injection molding machine.

Preference is given to a biological filler which is obtained from a renewable raw material.

The biological filler material is preferably obtained from rice husks, rice spelt, sisal, hemp, cotton, pinewood, kenaf, bamboo, flax and/or sugarcane, preferably from rice husks. Rice husks generally have a silicon dioxide content of more than about 20% by weight.

Preference is given to processed products of the aforementioned components, more preferably ash obtained from these components, especially rice husk ash. This ash features a high proportion of SiO₂.

Many of the aforementioned components are obtained as a by-product or waste product. They are therefore frequently available economically in high volumes.

There is also no competition with food production resulting from the use of rice husks. At the same time, the product is available in large volumes. The ash is used particularly as additive for concretes or steel. It is also possible to use the heat that arises in the course of production to generate energy.

The proportion of SiO₂ in the biological filler material is at least 60% by weight (determined by x-ray fluorescence spectroscopy), preferably between 60% by weight and 98% by weight.

Particular preference is given to a biological filler material having an SiO₂ content of at least 80% by weight, preferably at least 90% by weight. The content may be 80% by weight to 99% by weight, preferably 80% by weight to 98% by weight. More preferably 90% by weight to 99% by weight.

The silicon dioxide may comprise amorphous and crystalline components. Preference is given to amorphous silicon dioxide. Preferably, the amorphous components comprise at least 50% by volume of silicon dioxide, more preferably at least 80% by volume.

Rice husk ash in particular has a high proportion of amorphous silicon dioxide. Depending on the production, the proportion of crystalline SiO₂, especially of cristobalite, can be minimized, especially to below 20% by weight, preferably below 10% by weight, most preferably to below 5% by weight.

The biological filler material also comprises up to 30% by weight of further constituents, preferably up to 20% by weight. Preference is given to further oxides of Fe, Al, Zr, Na, K, Mg, Mn, Ca, each with proportions of 0% to 10% by weight, preferably 0% to 5% by weight, more preferably with proportions of 0% to 3% by weight.

In one embodiment of the invention, the biological filler material comprises at least following constituents:

| | % by wt. |
|---|---|
| SiO₂ | 80-99 |
| Fe₂O₃ | 0-3 |
| CaO | 0-3 |
| MgO | 0-3 |
| K₂O | 0-5 |
| Na₂O | 0-5 |
| ZrO₂ | 0-5 |

In addition, it is always also possible for further constituents to be present, such as 0% to 10% by weight of carbon, preferably 0% to 5% by weight, more preferably 0% to 1% by weight. In addition, impurities and small amounts of moisture may also be present.

In a further embodiment of the invention, the biological filler material comprises at least the following constituents:

| | % by wt. |
|---|---|
| SiO₂ | 80-99 |
| Fe₂O₃ | 0.1-1 |
| CaO | 0.1-1 |
| MgO | 0.1-2 |
| K₂O | 0.1-5 |
| Na₂O | 0.1-5 |
| ZrO₂ | 0-5 |

In addition, it is always also possible for further constituents to be present, such as 0% to 10% by weight of carbon, preferably 0% to 5% by weight, more preferably 0% to 1% by weight, most preferably 0.1% to 1% by weight. In addition, impurities and small amounts of moisture may also be present.

Preferably, the biological filler material has thermal stability of at least 1000° C.

Fillers having such a high content of SiO₂ not only have a low water absorption capacity but also allow higher temperatures in the course of processing. It is therefore possible to incorporate such fillers into many thermoplastics. Thus, processing temperatures of more than 150° C. or more than 200° C. are also possible. This allows incorporation, for example, into polyamides such as nylon-6,6.

Preferably, the biological filler material has a density of up to 2.5 g/cm³, preferably up to 2.4 g/cm³, preferably of up to 2.3 g/cm³. Preference is given to a density of at least 1.8 g/cm³. The density is therefore preferably within a range from 1.8 g/cm³ to 2.5 g/cm³, especially 1.8 g/cm³ to 2.3 g/cm³, very particularly from 1.8 to 2.2 g/cm³. The density is based on the density of the material, not the bulk density.

The particles of the biological filler are preferably slightly porous. It preferably has a specific surface area of 15 to 30 m²/g (BET measurement with nitrogen).

Rice husk ash in particular has a low density of up to 2.3 g/cm³, especially of 1.8 to 2.2 g/cm³. The density can be affected correspondingly by the production process. Together with the high silicon dioxide content, it is possible to produce similar composites with a high filler level, which have a low-density compared to standard filler materials such as talc or chalk, mica, wollastonite, etc.

In one embodiment of the invention, the biological filler material is in powder form. Preferably with a bulk density of 200 to 800 kg/m³.

Preferably, suspensions of the biological filler material in water have a pH of 4-7, in another embodiment of 6-8 (in each case measured as 5% by weight at room temperature).

The proportion of the biological filler material is preferably at least 10% by weight based on the overall composition, more preferably from 10% by weight to 80% by weight, particular preference being given to a proportion of 10% by weight to 40% by weight.

In another embodiment of the invention, the proportion of the biological filler material is at least 20% by volume, preferably from 20% to 45% by volume, of the composition.

Long glass fibers used as component (c) are endless or continuous glass fibers or filaments, the length of which is limited merely by the capacity of the coil on which the filament has been wound. The resulting fiber length in the composition is determined by the processing thereof. In the case of a pelletized thermoplastic, the fiber length is determined by the cut length of the pellets, meaning that the cut length of the pellets is 5 to 50 mm, preferably 5 to 30 mm, more preferably 7 to 25 mm. (The expression “pellets” in connection with the invention refers to the plastic pellets. Pellets are the usual form in which thermoplastic compositions with or without additives are commercially available.) Typically, a fiber filament has a diameter of 3 to 25 and preferably 8 to 22 micrometers.

The long glass fibers themselves may be selected from the group of E long glass fibers, A long glass fibers, C long glass fibers, D long glass fibers, M long glass fibers, S long glass fibers and/or R long glass fibers, preference being given to E long glass fibers.

The proportion of long glass fibers in the composition is preferably at least 5% by weight, more preferably at least 10% by weight. Preferred ranges are 5% to 30% by weight and 10% to 25% by weight. A proportion of at least 10% by weight leads to a significant rise in the impact resistance and modulus of elasticity in the finished product.

It has now been found that, surprisingly, the addition of biological fillers of the invention gives another improvement in impact resistance. Thus, compositions comprising a comparable total content of long glass fibers and biological filler material have better properties than a comparable composition comprising long glass fibers only.

The long glass fibers may have been surface modified with what is called a size and have been impregnated with the thermoplastics or thermoplastic blends used. The long glass fibers themselves may also have been provided with an amino- or epoxysilane coating. Preference is given to a silane size, for example silanes modified with amino or hydroxyl groups, such as aminoalkyl- or hydroxyalkyltrialkoxysilanes.

In order to assure good mechanical properties in the resulting long glass fiber-containing pellets and particularly in the component produced therefrom, very good wetting and impregnation is to be achieved.

This also applies to the so-called chopped glass fibers having a typical length/diameter ratio (L/D ratio). This also applies to the continuous glass fiber/long glass fiber composites, and tapes in the standard L/D ratios that are technically possible.

It is assumed that the high silicon content, especially amorphous silicon, of the biological component contributes to the compatibility of the glass fibers in the composite material.

In one embodiment of the present invention, the composition further comprises at least one additive. Examples of additives are compatibilizers or couplers (coupling agents), for example compounds based on maleic anhydride, maleated polyethylenes or maleated polypropylenes, or copolymers of ethylene or propylene and acrylic acid, methacrylic acid or trimellitic acid. The content of such couplers is preferably between 0% and 8% by weight.

Further examples of suitable additives are stabilizers, especially light and UV stabilizers, for example sterically hindered amines (HALS), 2,2,6,6-tetramethyl-morpholine N-oxides or 2,2,6,6-tetramethylpiperidine N-oxides (TEMPO) and other N oxide derivatives such as NOR.

Further examples of suitable additives are UV absorbers, for example benzophenone or benzotriazoles.

Further examples of suitable additives are pigments which can likewise bring about stabilization against UV light, for example titanium dioxide (for example as white pigment), or suitable substitute white pigments, carbon black, iron oxide, other metal oxides and organic pigments, for example azo and phthalocyanine pigments.

Further examples of suitable additives are biocides, especially fungicides.

Further examples of suitable additives are acid scavengers, for example alkaline earth metal hydroxides or alkaline earth metal oxides or fatty acid salts of metals, especially metal stearates, more preferably zinc stearate and calcium stearate, and additionally chalks and hydrotalcites. It is possible here for some fatty acid salts of metals, especially zinc stearate and calcium stearate, also to function as lubricants in the course of processing.

Further examples of additives are antioxidants based on phenols, such as alkylated phenols, bisphenols, bicyclic phenols or antioxidants based on benzofuranones, organic sulfides and/or diphenylamines.

Further examples of suitable additives are plasticizers, for example esters of dicarboxylic acids such as phthalates, organic phosphates, polyesters and polyglycol derivatives.

Further examples of suitable additives are impact modifiers (e.g. polyamides, polybutylene terephthalates (PBTs)) and flame retardants. Examples of flame retardants, especially polycarbonate-based compositions, are halogen compounds, especially based on chlorine and bromine, and phosphorus-containing compounds. Preferably, the compositions contain phosphorus flame retardants from the groups of the mono- and oligomeric phosphoric and phosphoric esters, phosphonate amines and phosphazenes, but it is also possible to use mixtures of two or more components selected from one or various of these groups as flame retardant. It is also possible to use other phosphorus compounds that are not specifically mentioned here alone or in any desired combination with other flame retardants. Further flame retardants may be organic halogen compounds such as decabromobisphenyl ether, tetrabromobisphenol, inorganic halogen compounds such as ammonium bromide, nitrogen compounds such as melamine, melamine-formaldehyde resins, inorganic hydroxide compounds such as magnesium hydroxide, aluminum hydroxide, inorganic compounds such as antimony oxides, barium metaborate, hydroxoantimonate, zirconium oxide, zirconium hydroxide, molybdenum oxide, ammonium molybdate, zinc borate, ammonium borate, barium metaborate, talc, silicate, silicon oxide and tin oxide, and also siloxane compounds.

The flame retardants are often used in combination with so-called antidripping agents, which reduce the tendency of the material to produce burning drips in the event of fire. Examples here include compounds of the substance classes of the fluorinated polyolefins, the silicones, and aramid fibers. These may also be used in the compositions of the invention. Preference is given to using fluorinated polyolefins as antidripping agents.

By virtue of the high silicon dioxide content of the biological filler material, it is possible to reduce the use of flame retardants.

Further examples of additives are inorganic fillers present in the form of particles and/or in laminar form, such as talc, chalk, kaolin, mica, wollastonite, kaolin, silicas, magnesium carbonate, magnesium hydroxide, calcium carbonate, feldspar, barium sulfate, ferrite, iron oxide, metal powders, oxides, chromates, glass beads, hollow glass beads, pigments, silica, hollow spherical silicate fillers and/or sheet silicates. These preferably have a particle size between 2 and 500 μm (measured by light scattering).

The composition may also additionally contain crosslinkers which can lead to crosslinking of the thermoplastic, for example on irradiation or heating.

If the molding compositions produced from the composition are to be foamed, it is possible to introduce chemical or physical blowing agents in liquid or solid form into the composition, for example sodium bicarbonate with citric acid or thermally labile carbamates. Preference is given to using endothermic foaming agents for this purpose. A further method of achieving foaming is the use of microspheres filled, for example, with gases or evaporable liquids. Suitable filling materials are particularly alkanes such as butane, pentane or hexane, but also the halogenated derivatives thereof, for example dichloromethane or perfluoropentane.

Alternatively, the foaming can also be achieved by establishment of appropriate process parameters (extrusion temperature, cooling rate of the solid profile), when the composition contains substances that become gaseous under the process conditions (e.g. water, hydrocarbons, etc.). The pores are preferably closed pores.

It is also possible to use mixtures of additives.

Examples of further reinforcers used as additives include carbon fibers, graphite fibers, boron fibers, aramid fibers (p- or m-aramid fibers (e.g. Kevlar® or Nomex®, DuPont) or mixtures thereof) and basalt fibers, and it is also possible to use the reinforcing fibers mentioned in the form of long fibers or filaments having the customary ratios (length to diameter) in the form of a mixture of various fibers. It is also possible to add thermoplastic fibers (for example composed of PP, PA, PET, PP-silicon fibers, etc.) or plant fibers, natural fibers or fibers of natural polymers.

In the case of addition of an additive, especially of a filler, however, it should be ensured that the viscosity of the composite material does not fall below a value corresponding to an MFI of PP of less than 10 g/10 min.

The additives are preferably present with a content of 0% to 30% by weight, preference being given to a content of 0% to 20% by weight.

The composition of the invention is generally produced by mixing the respective constituents in a known manner and melt-compounding and melt-extruding them at temperatures of 200° C. to 300° C. in standard equipment such as internal kneaders, extruders and twin-shaft screws.

It is also possible first to undertake compounding of the thermoplastic and the biological filler material.

The mixing of the individual constituents can be effected in a known manner either successively or simultaneously, either at about 20° C. (room temperature) or at higher temperature. The long glass fibers are supplied as continuous “ravings” or glass fiber bundles in a structure in which the molten thermoplastic or thermoplastic blend is also supplied together with the biological filler material (cf. WO 95/28266 and U.S. Pat. No. 6,530,246 B1). This means that the long glass fibers or other fibers such as carbon fibers or aramid fibers are subjected continuously to the wetting or impregnation process. The number of individual filaments in a roving is 200 to 20 000, preferably 300 to 10 000, more preferably 500 to 2000.

In what is called the direct process for molding production, it is possible to produce the composition of the invention in an injection molding compounder and process it directly to moldings.

Preferably, the filler material is the biological filler material described for the composition.

The molding compositions of the invention can be used to produce shaped bodies of any kind. These can be produced by injection molding, extrusion and blowmolding processes. A further form of processing is the production of shaped bodies by thermoforming from sheets or films produced beforehand. These processing steps can lead once again to a change in the particle size and/or in the length of the long glass fibers.

The glass fibers are present in the resulting moldings preferably in a mean fiber length of 0.5 to 50 mm, preferably 1.0 to 40 mm, more preferably of 1.5 to 15 mm, with at least a proportion of more than 40%, preferably more than 70%, more preferably more than 80%, of the glass fibers having a length exceeding 1 mm.

The filaments are arranged in a unidirectional manner in the long fiber pellets.

The long glass fiber-reinforced thermoplastics according to the invention have good mechanical properties which surpass those of what are called short fiber-reinforced thermoplastics. Short fiber-reinforced thermoplastics refer to materials where the fibers in the form of chopped glass are mixed with the other components in an extruder. Typically, the short fiber-reinforced thermoplastics exhibit a glass fiber length in the pellets of 0.2 to 0.4 mm. The fibers are present randomly in the short fiber pellets, i.e. in unordered form.

A further embodiment of the invention relates to a composite material comprising components (a) and (b) of the composition and glass fibers, wherein the glass fibers are a continuous unidirectional glass mat or in which the glass fibers are a continuous random glass mat.

Such composite materials are also referred to as glass mat-reinforced thermoplastics (GMT). The amounts specified apply analogously to the specifications for the composition of the invention, with the proportions specified for long glass fibers relating to the glass fiber mats.

The glass fibers in the composite material have a length of at least 0.5 mm up to an infinite length in the case of a continuous glass mat. Preference is given to a length of at least 5 mm, more preferably at least 10 mm.

The glass mats are typically produced from glass fibers having a homogeneous fiber size, for example according to the known specification (K or T).

The present invention further provides a masterbatch comprising at least one thermoplastic, at least one biological filler material and long glass fibers, in accordance with the embodiments described above, with the difference that the masterbatch especially includes high proportions of biological filler material and/or long glass fibers. Thus, the masterbatch includes a proportion of biological filler material of at least 30% by weight, preferably 30% to 60% by weight. The proportion of long glass fibers is preferably at least 20% by weight, preferably 20% to 60% by weight. Further constituents present may be 5% to 30% by weight of at least one thermoplastic and 0% to 6% by weight of additives, preferably 0.5% by weight to 6% by weight. All of this with the proviso that the proportions of the constituents add up to 100% by weight.

Preferably, the proportions in the masterbatch are 30% to 40% by weight of biological filler and 30% to 40% by weight of long glass fibers.

Examples of shaped bodies produced from glass fiber-reinforced thermoplastics according to the invention are films, profiles, housing parts of any kind, for example for automobile interiors, such as instrument panels, domestic appliances such as juice presses, coffee machines, mixers; for office equipment such as monitors, printers, copiers; for plates, tubes, electrical installation ducts, windows, doors and profiles for the construction sector, internal fitting and outdoor applications, such as building interior or exterior parts; in the field of electrical engineering, such as for switches and plugs.

Examples of building interior parts are handrails, for example for indoor staircases, and panels. Examples of building exterior parts are roofs, facades, roof constructions, window frames, verandas, handrails for outdoor staircases, decking planks and cladding, for example for buildings or building parts. Examples of profile parts are technical profiles, connecting hinges, moldings for indoor applications, for example moldings having complex geometries, multifunctional profiles or packaging parts and decorative parts, furniture profiles and floor profiles. Composite materials of the invention are additionally suitable for packaging, for example for boxes and crates. The present invention further provides for the use of composite materials of the invention as or for production of furniture, for example of tables, chairs, especially garden furniture and benches, for example park benches, for production of profile parts and for production of hollow bodies, for example hollow chamber profiles for decking planks or window benches.

Moldings of the invention exhibit excellent weathering resistance, and additionally outstanding grip and very good mechanical properties, for example impact resistance, good flexural modulus of elasticity and low water absorption, which leads to good weathering dependence.

The present invention thus also provides a process for producing molding compositions reinforced with long glass fibers, comprising at least one thermoplastic and at least one biological filler material.

Preference is given to the process for producing the thermoplastic compositions of the invention in which

i) a bundle of long glass fibers/filaments is wetted with the melt of optionally at least one thermoplastic and at least one biological filler material as described above; and
ii) is cooled.

In a preferred embodiment, a pelletized material is produced. For this purpose, after step ii), the wetted fiber bundle/filament bundle is cut into pellets with a cut length of 5 to 50 mm.

The melt composed of components (a) and (b) is obtained as described above.

The process may also include further, unspecified steps.

The invention also relates to the use of the biological filler material of the invention having a silicon dioxide content of at least 60% by weight, preferably at least 80% by weight, more preferably rice husk ash, as filler material in long glass fiber-reinforced composite plastics, as per the composition of the invention or the masterbatch.

The invention also relates to the use of the masterbatch of the invention for production of long glass fiber-reinforced plastics.

Further details and features will be apparent from the description of preferred working examples which follows, in conjunction with the dependent claims. In this context, the respective features may be implemented alone or several may be implemented in combination with one another. The ways of achieving the object are not restricted to the working examples. For example, specified ranges always include all unspecified intermediate values and all conceivable sub-intervals.

### EXAMPLES

Several compositions were produced from polypropylene (PP) or nylon-6,6 (PA), long glass fibers and further components. For this purpose, all constituents except for the glass fibers were first melt-compounded in a kneader, before the glass fibers were fed in. The extruded pallets were processed further to give test specimens (table 2). C1 to C4 are comparative experiments. This was done using kneaders with an extruder or twin-screw extruder. The biological component used was rice husk ash (for constituents see table 1).

The properties of the test specimens produced are shown in table 3.

It has been found that, surprisingly, the biological component, given the same content of long glass fibers, leads to a further distinct increase in modulus of elasticity. However, a distinct increase in the notch impact resistance is particularly advantageous. This shows that there is especially an advantageous interaction of the high silicon dioxide content of the biological filler and the long glass fibers.

TABLE 1

| | Sample 1 | Sample 2 |
|---|---|---|
| SiO₂ % by wt. | 85-97 | 92.3 |
| Fe₂O₃ % by wt. | 0.1-0.28 | 0.38 |
| Al₂O₃ % by wt. | 0.1-0.44 | 0.28 |
| CaO % by wt. | 0.1-0.27 | 0.25 |
| MgO % by wt. | 0.1-0.4 | |
| K₂O % by wt. | 0.2-1.3 | |
| Na₂O % by wt. | 0.1-0.3 | |
| C % by wt. | 0.1-1 | |
| Density g/cm³ | 2.2 | |
| Melting point ° C. | 1710 | |

TABLE 2

| | Sample | | | | | | | |
|---|---|---|---|---|---|---|---|---|
| | 1 | 2 | 3 | 4 | C1 | C2 | C3 | C4 |
| Thermoplastic | PP | PP | PA | PA | PP | PP | PP | PP |
| Glass fibers (% by wt.) | 10 | 20 | 10 | 20 | 0 | 20 | 30 | 40 |
| Rice husk ash (% by wt.) | 10 | 20 | 10 | 20 | 0 | 0 | 0 | 0 |

TABLE 3

| | Sample | | | | | | | |
|---|---|---|---|---|---|---|---|---|
| | 1 | 2 | 3 | 4 | C1 | C2 | C3 | C4 |
| Tensile modulus | 3.3 | 5.7 | 6.1 | 8.9 | 1.45 | 2.9 | 7.0 | 9.0 |
| of elasticity (GPa) | | | | | | | | |
| according to | | | | | | | | |
| ISO 527 | | | | | | | | |
| Tensile strength | 45 | 62 | 57 | 96 | | | | |
| [MPa] | | | | | | | | |
| Elongation at | 2.1 | 1.7 | 1 | 1.2 | | | | |
| break [%] | | | | | | | | |
| Charpy notch | 23 | 23 | 8 | 14 | 5 | 4.5 | 12 | 16 |
| impact resistance | | | | | | | | |
| at 23° C. (kJ/m²) | | | | | | | | |
| according to | | | | | | | | |
| ISO 179/1eA | | | | | | | | |
| unnotched | | | | | | | | |

1. A composition, comprising:
a) at least one thermoplastic;
b) at least one biological filler material having a silicon dioxide content of at least 60% by weight; and
c) at least one long glass fiber having a length of at least 0.5 mm and a diameter of 3 to 25 μm.

2. The composition as claimed in claim 1, wherein the biological filler material has a silicon dioxide content of at least 80% by weight.

3. The composition as claimed in claim 1, wherein the biological filler material is obtained from a renewable raw material.

4. The composition as claimed in claim 3, wherein the biological filler material has been obtained from at least one of rice husks, rice spelt, sisal, hemp, cotton, pinewood, kenaf, bamboo, flax or sugarcane.

5. The composition as claimed in claim 1, wherein the biological filler material comprises rice husk ash.

6. The composition as claimed in claim 1, wherein the biological filler material has a density of up to 2.5 g/cm³.

7. The composition as claimed in claim 6, wherein the biological filler material has a density of 1.8 to 2.3 g/cm³.

8. The composition as claimed in claim 1, wherein the at least one thermoplastic is selected from the group consisting of polyolefins, polyamides, polyimides, polystyrenes, polycarbonates, polyesters, polyethers, polysulfones, and the copolymers or mixed polymers thereof.

9. A process for producing thermoplastic compositions as claimed in claim 1, wherein
i) a bundle of long glass fibers/filaments having a length of at least 0.5 mm and a diameter of 3 to 25 μm is wetted with a melt of at least one thermoplastic and at least one biological filler material; and
ii) is cooled.

10. The process as claimed in claim 9, wherein the wetted fiber bundle is cut into pellets with a cut length of 5 to 50 mm.

11. The process as claimed in claim 9, wherein either of the biological filler material has a silicon dioxide content of at least 80% by weight.

12. The process as claimed in claim 9, wherein the biological filler material comprises rice husk ash.

13. A shaped body produced from a composition as claimed in claim 1.

14. The shaped body as claimed in claim 13, wherein the long glass fibers/filaments in the shaped body are present with a mean fiber length of 0.5 to 50 mm.

15. A composite material comprising components (a) and (b) as claimed in claim 1, wherein the composite material comprises glass fibers, wherein the glass fibers are a continuous unidirectional glass mat or in which the glass fibers are a continuous random glass mat.

16. A masterbatch comprising a composition as claimed in claim 1 having a content of at least 30% by weight of biological filler material.

17. A profile, item of furniture, housing part or film comprising a composition as claimed in claim 1.

18. A profile, item of furniture, housing part or film comprising a composite material as claimed in claim 15.
